(19) United States
(12) Patent Application Publication
(10) Pub. No.: US 2008/0201039 A1
(43) Pub. Date: Aug. 21, 2008

(54) DRIVING ASSIST DEVICE FOR VEHICLE

(75) Inventors: Satoru MATSUOKA, Hiroshima (JP); Teru IYOTA, Hiroshima (JP); Masashi UTSUMI, Hiroshima (JP); Hironobu YONEZAWA, Hiroshima (JP); Koji IWASE, Hiroshima (JP); Hideki TAKAHASHI, Hiroshima (JP)

Correspondence Address: Studebaker & Brackett PC, 1890 Preston White Drive, Suite 105, Reston, VA, 20191, US

(73) Assignee: MAZDA MOTOR CORPORATION, Hiroshima (JP)

(21) Appl. No.: 11/972,053

(22) Filed: Jan. 10, 2008

(30) Foreign Application Priority Data
Feb. 15, 2007 (JP) 2007-035080

(51) Int. Cl. B60W 30/08

(52) U.S. Cl. 701/41; 701/70; 701/301

(57) ABSTRACT

In a driving assist device for a vehicle, there are provided a specified-operation detecting device to detect that a specified operation is conducted by a driver at a normal driving state, a normal-driving-state stimulation proving device to provide the driver with a specified stimulation associated with the specified operation when conduction of the specified operation by the driver is detected, a collision-likelihood determining device to determine a likelihood of collision of the vehicle against an obstacle, a collision-avoidance operation determining device to determine a necessary operation to be conducted by the driver for avoidance of collision when the likelihood of collision of the vehicle against the obstacle is determined, and a collision-avoidance-state stimulation proving device to provide the driver with a stimulation associated with the necessary operation for collision avoidance so that the driver can be encouraged to conduct the necessary operation for collision avoidance.

### BACKGROUND OF THE INVENTION

The present invention relates to a driving assist device for a vehicle.

Conventionally, various technologies for assisting a safe driving of a vehicle have been proposed. US Patent Application Publication No. 2005/0128063 A1, for example, discloses a driving assist device for a vehicle in which a warning sound is produced when it is determined that the vehicle could not stop before an obstacle existing in front of the traveling vehicle and therefore it could have a likelihood of collision against the obstacle.

The technology disclosed in the above-described patent, however, has a problem in that there may exist a time lag until a driver can conduct a necessary operation to avoid collision against the obstacle after the driver have recognized the collision likelihood based on the warning sound and the collision could not be surely prevented.

### SUMMARY OF THE INVENTION

The present invention has been devised in view of the above-described technical problem, and an object of the present invention is to provide a driving assist device for a vehicle that can avoid a collision surely by encouraging a driver to conduct any necessary operation to avoid it quickly.

According to the present invention, there is provided a driving assist device for a vehicle, comprising a specified-operation detecting device operative to detect that a specified operation is conducted by a driver at a normal driving state, a normal-driving-state stimulation proving device operative to provide the driver with a specified stimulation that is associated with the specified operation when conduction of the specified operation by the driver is detected by the specified-operation detecting device, a collision-likelihood determining device operative to determine a likelihood of collision of the vehicle against an obstacle, a collision-avoidance operation determining device operative to determine a necessary operation to be conducted by the driver for avoidance of collision when the likelihood of collision of the vehicle against the obstacle is determined by the collision-likelihood determining device, and a collision-avoidance-state stimulation proving device operative to provide the driver with a stimulation that is associated with the necessary operation for avoidance of collision so that the driver can be encouraged to conduct the necessary operation for avoidance of collision that is determined by the collision-avoidance operation determining device.

According to the present invention, since the stimulation and the specified operation are memorized by the driver in association with each other, the driver can be encouraged to conduct any necessary operation to avoid the collision quickly.

According to an embodiment of the present invention, the stimulation is configured to be a plurality of recognizable stimulations, which are associated with a specified necessary operation for avoidance of collision, respectively. Thereby, a suitable operation to avoid the collision can be selected according to various situations, thereby encouraging the driver to conduct the suitable operation to avoid the collision quickly.

According to another embodiment of the present invention, the necessary operation for avoidance of collision comprises at least one of a steering operation, an acceleration-off operation, a braking-on operation, and a watching operation, and the collision-avoidance operation determining device is configured to determine at least one of the steering operation, acceleration-off operation, braking-on operation, and watching operation as the necessary operation for avoidance of collision to be conducted by the driver. Thereby, the suitable operation to avoid the collision can be selected according to the various situations.

According to another embodiment of the present invention, the normal-driving-state stimulation proving device is configured to provide the driver with a subliminal stimulation that is less stimulative than a recognition limit of the driver so as to be memorized by the driver subliminally. Thereby, the driver can be made memorize the stimulation associated with the specified operation subliminally, without letting the driver feel uncomfortable.

According to another embodiment of the present invention, the collision-avoidance-state stimulation proving device is configured to provide the driver with a recognizable stimulation that is more stimulative than a recognition limit of the driver. Thereby, the driver can be surely encouraged to conduct any necessary operation to avoid the collision.

According to another embodiment of the present invention, the stimulation provided by the normal-driving-state stimulation proving device is a warning sound. Thereby, the stimulation and the specified operation can be memorized by the driver in association with each other by using the warning sound, so the driver can be properly encouraged to conduct any necessary operation to avoid the collision quickly.

According to another embodiment of the present invention, the stimulation provided by the normal-driving-state stimulation proving device is an image indicated on a head-up display. Thereby, the stimulation and the specified operation can be memorized by the driver in association with each other by using the image indicated on the head-up display, so the driver can be properly encouraged to conduct any necessary operation to avoid the collision quickly.

According to another embodiment of the present invention, the stimulation provided by the normal-driving-state stimulation proving device is a steering vibration. Thereby, the stimulation and the specified operation can be memorized by the driver in association with each other by using the steering vibration, so the driver can be properly encouraged to conduct any necessary operation to avoid the collision quickly.

According to another embodiment of the present invention, the normal-driving-state stimulation proving device is configured to provide the driver with the stimulation at specified limited number of times after a vehicle start. Thereby, since providing the driver with the stimulation is cancelled after the specified number of times that is suitable for the driver to subliminally memorize the stimulation and the specified operation in association with each other, for example, processing can be simplified.

Other features, aspects, and advantages of the present invention will become apparent from the following description which refers to the accompanying drawings.

### BRIEF DESCRIPTION OF THE DRAWINGS

FIG. 1 is an explanatory diagram schematically showing a vehicle equipped with a driving assist device according to an embodiment of the present invention.

FIG. 2 is a block diagram showing components of the driving assist device and a control unit to control them.

FIG. 3 is an explanatory diagram regarding operations that are conducted by a driver at a normal driving state or at a collision-avoidance state, which are associated with respective stimulations.

FIG. 4 is a chart showing relationships between the operations conducted by the driver at the normal driving state or at the collision-avoidance state and a warning sound.

FIG. 5 is a chart showing relationships between the operations conducted by the driver at the normal driving state or at the collision-avoidance state and an image displayed on a head-up display.

FIG. 6 is a chart showing relationships between the operations conducted by the driver at the normal driving state or at the collision-avoidance state and a signal wave for a steering vibration.

FIG. 7 is a chart showing relationships between the operations conducted by the driver at the normal driving state or at the collision-avoidance state and the warning sound, signal wave for the steering vibration, and image displayed on the head-up display.

FIG. 8 is a first flowchart of a driving assist processing that is executed by the control unit.

FIG. 9 is a second flowchart of the driving assist processing that is executed by the control unit.

### DETAILED DESCRIPTION OF THE INVENTION

Hereinafter, a preferred embodiment of the present invention will be described referring to the accompanying drawings.

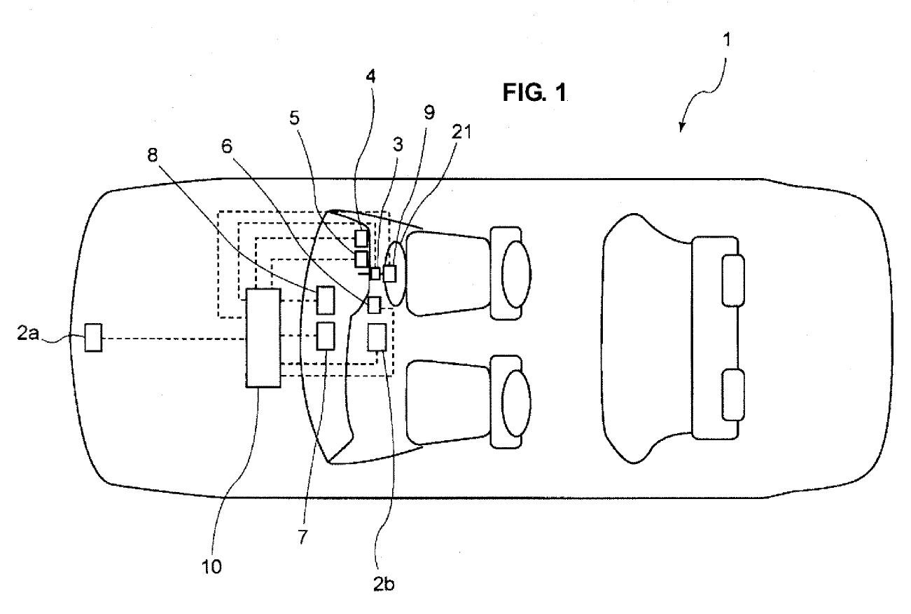

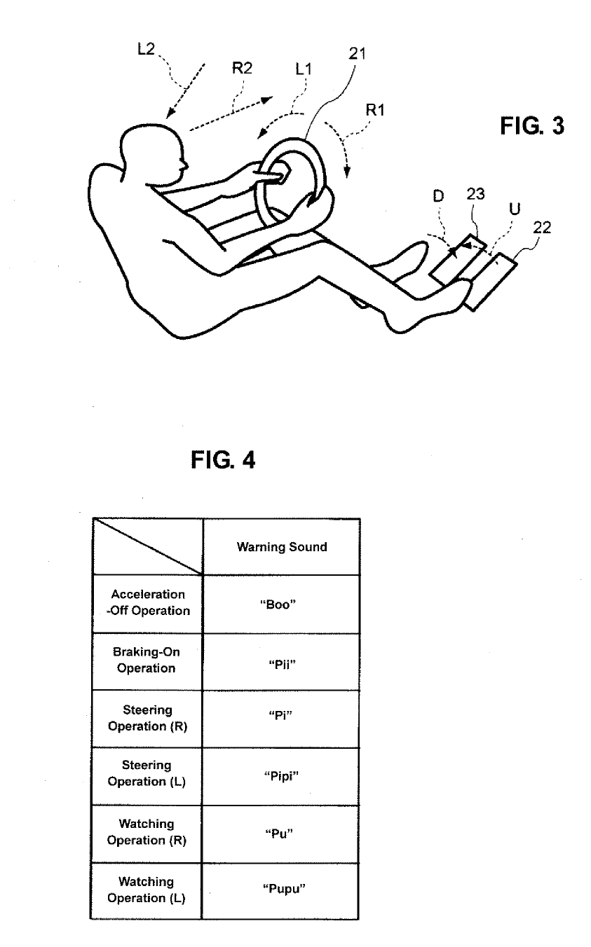

FIG. 1 is an explanatory diagram schematically showing a vehicle equipped with a driving assist device according to an embodiment of the present invention. A vehicle 1 is equipped with, as components of a driving assist device, a pair of obstacle detecting sensors 2a, 2b to detect an obstacle in front of a traveling vehicle, which may be comprised of a radar or camera, for example, a steering angle sensor 3 to detect a steering angle of a steering wheel 21 (see FIG. 3), an acceleration pedal sensor 4 to detect a pedal-pressing amount of an acceleration pedal 22 (see FIG. 3), and a brake pedal sensor 5 to detect a pedal-pressing amount of a brake pedal 23 (see FIG. 3).

The vehicle 1 is further equipped with an eyes-direction detecting sensor 6 to detect a direction of driver's eyes, a warning-sound producer 7 to produce a warning sound as a stimulation provided to the driver, a head-up display output device 8 to indicate an image on a head-up display as another stimulation provided to the driver and a steering-vibration generating actuator 9 to give a vibration to the steering wheel 21 as further another stimulation provided to the driver. Herein, a conventionally well-known electronic steering derive motor that is provided at a steering shaft portion to control the steering wheel 21 may be applied as the steering-vibration generating actuator 9.

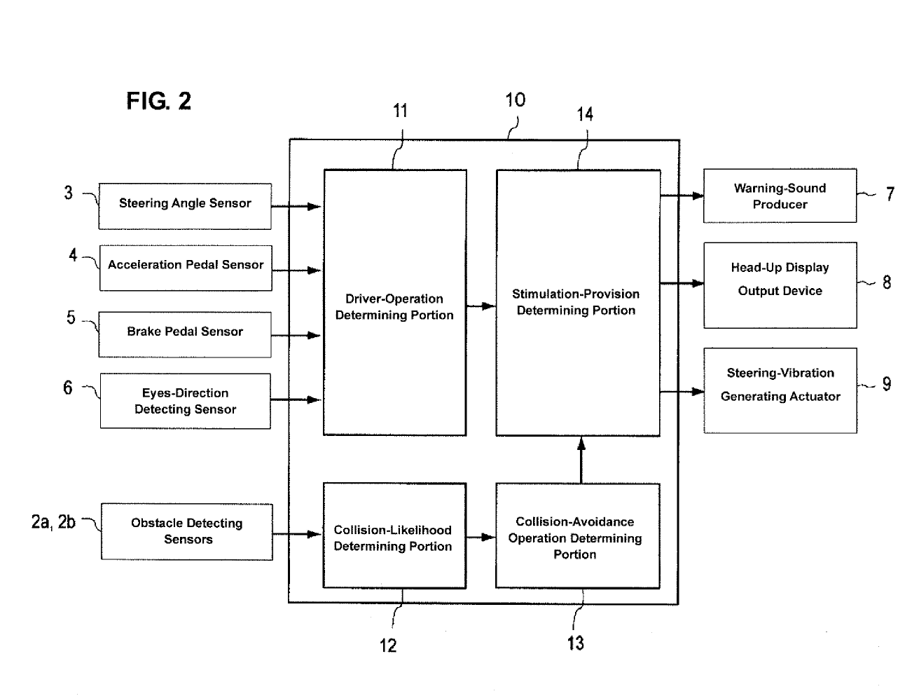

The vehicle 1 is further equipped with a control unit 10 that is comprised of a micro computer, which is electrically coupled to the above-described sensors and devices. The control unit 10 executes various processing for controlling the devices based on signals from the sensors. FIG. 2 is a block diagram showing the above described components and the control unit 10. As shown in FIG. 2, to the control unit 10 are electrically coupled to the obstacle detecting sensors 2a, 2b, steering angle sensor 3, acceleration pedal sensor 4, brake pedal sensor 5, and eyes-direction detecting sensor 6.

The control unit 10 of the present embodiment controls the warning-sound producer 7, the head-up display output device 8 and the steering-vibration generating actuator 9 at a normal driving state so as to provide the driver with stimulations according to a specified operation of the driver. Herein, the stimulations provided are associated with respective operations of the driver. Thereby, the stimulations and the operations are subliminally memorized by the driver in association with each other. Then, when there occurs a likelihood of collision, the control unit 10 determines necessary operations to avoid the collision and controls the warning-sound producer 7, the head-up display output device 8 and the steering-vibration generating actuator 9 so as to provide the driver with stimulations associated with the necessary operations to avoid the collision. Herein, the stimulation is configured so that the same manner of stimulation is set for common operations of the specified operation that is conducted by the driver at the normal driving state and the necessary operation to be conducted by the driver at a collision-avoidance state (to avoid the collision). Accordingly, the driver can react the stimulation provided so quickly that the suitable operation to avoid the collision can be surely executed by the driver.

More specifically, as shown in FIG. 2, the control unit 10 has a driver-operation determining function of determining the operation conducted by the driver at the normal driving state (hereinafter, referred to as “driver operation”) based on signals of the steering angle sensor 3, acceleration pedal sensor 4, brake pedal sensor 5, and eyes-direction detecting sensor 6, a collision-likelihood determining function of determining the likelihood of collision of the vehicle 1 against the obstacle based on the obstacle detecting sensors 2a, 2b, a collision-avoidance operation determining function of determining a necessary operation to be conducted by the driver to avoid the collision when the likelihood of collision is determined, and a stimulation-provision determining function of outputting control signals to the warning-sound producer 7, the head-up display output device 8 and the steering-vibration generating actuator 9 so as to provide stimulations that have been in advance associated with the driver operation and the necessary operation for collision avoidance based on the above-described determinations of the driver operation and the necessary operation for collision avoidance.

Herein, the above-described functions respectively correspond to a driver-operation determining portion 11, a collision-likelihood determining portion 12, a collision-avoidance operation determining portion 13, and a stimulation-provision determining portion 14 in FIG. 2. Although these portions are illustrated as if they were hardware constitutions in FIG. 2, this is because relationships between the control unit 10 and these electrically coupled to the unit 10 are just shown schematically.

According to the above-described constitution of the control unit 10, the stimulation associated with the driver operation are provided to the driver from the warning-sound producer 7, the head-up display output device 8 and the steering-vibration generating actuator 9 according to determination of the driver operation. Thereby, the stimulation and the specified driver operation are subliminally memorized by the driver in association with each other. In the present embodiment, provision of the stimulation is conducted at specified limited number of times after an engine start for each driver operation. Herein, the specified number of times is set to be suitable for the driver to subliminally memorize the stimulation and the specified driver operation in association with each other.

Then, in a case where after the above-described subconscious memorization of the stimulation by the driver is complete, the warning-sound producer 7, the head-up display output device 8 or the steering-vibration generating actuator 9 output (provide) the stimulation associated with the collision-avoidance operation according to the determination of the collision-avoidance operation (the necessary operation for collision avoidance). The driver responds to the stimulation outputted (provided) and reflexively conducts the specified driver operation that is associated with the stimulation outputted. Herein, since the stimulation is configured so that the same manner of stimulation is set for common operations of the driver operation and the collision-avoidance operation (the necessary operation for collision avoidance), the driver can quickly conduct the suitable operation for the collision avoidance. Accordingly, the collision of the traveling vehicle 1 against the obstacle can be surely avoided.

FIG. 3 is an explanatory diagram regarding the driver operation and the collision-avoidance operation that are associated with respective stimulations. In the present embodiment, as shown in FIG. 3, respective operations of a steeling operation for right turn or left turn of the steering wheel 21 denoted by arrows R1, L1, an off-operation of the acceleration pedal 22 denoted by an arrow U, an on-operation of the brake pedal 23 denoted by an arrow D, and a left and right watching operation denoted by arrows L2, R2 are associated with different stimulations, respectively. Herein, different stimulations are set for different directions (right or left) of the operations of the steering operation of the steering wheel 21 and the watching operation.

FIG. 4 is a chart showing relationships between the driver operation/collision-avoidance operation and a warning sound produced by the warning-sound producer 7. As shown, recognizably-different warning sounds are set for the specified driver operation/collision-avoidance operation. In the present embodiment, the warning sound to be produced at the normal driving state is set to a subliminal stimulation that is less stimulative than a recognition limit of the driver so as to be memorized by the driver subliminally, that is, its frequency is out of the range of hearing (i.e., lower than 20 Hz or greater than 20 kHz, for example). Additionally, the producing time, sound volume and the frequency of the warning sound outputted are set at respective appropriate levels so that the driver does not feel so uncomfortable. Meanwhile, the warning sound to be produced at the collision-avoidance state is set to a recognizable stimulation that is more stimulative than the recognition limit of the driver. Accordingly, the driver is not made feel so uncomfortable with the warning sound at the normal driving state, while the drive can be made surely recognize the likelihood of collision at the collision-avoidance state.

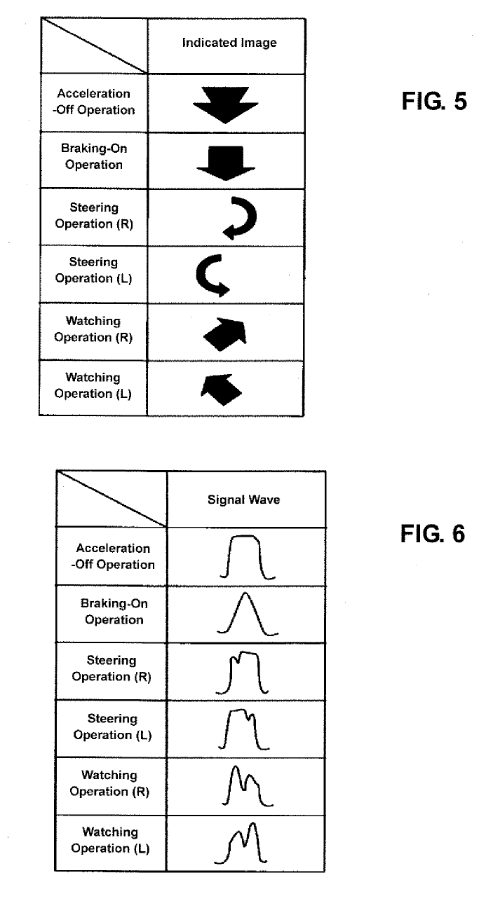

FIG. 5 is a chart showing relationships between the driver operation/collision-avoidance operation and an image displayed on the head-up display output device 8. As shown, recognizably-different images are set for the specified driver operation/collision-avoidance operation. In the present embodiment, the image to be displayed at the normal driving state is set to the subliminal stimulation that is less stimulative than a recognition limit of the driver so as to be memorized by the driver subliminally, that is, its display time is very short (i.e., 0.05-0.1 sec, for example). Additionally, the indication time, color and brightness of the image indicated are set at respective appropriate levels so that the driver does not feel so uncomfortable. Meanwhile, the image to be indicated at the collision-avoidance state is set to the recognizable stimulation that is more stimulative than a recognition limit of the driver, i.e., the image with a longer display time. Accordingly, the driver is not made feel so uncomfortable with the image display at the normal driving state, while the drive can be made surely recognize the likelihood of collision at the collision-avoidance state.

FIG. 6 is a chart showing relationships between the driver operation/collision-avoidance operation and a signal wave for a steering vibration that controls the steering-vibration generating actuator 9. As shown, recognizably-different signal wave for the steering vibration are set for the specified driver operation/collision-avoidance operation. In the present embodiment, the signal wave for the steering vibration to be used at the normal driving state is set to the one that can generate a vibration of a subliminal stimulation that is less stimulative than a recognition limit of the driver so as to be memorized by the driver subliminally, that is, its vibration pulse width is very short (i.e., 0.1 sec of vibration pulse width, for example). Additionally, the vibration level, frequency, time of the signal wave for the steering vibration used are set at respective appropriate levels so that the driver does not feel so uncomfortable. Meanwhile, the signal wave to be used at the collision-avoidance state is set to the one that can generate a vibration of a recognizable stimulation that is more stimulative than a recognition limit of the driver. Accordingly, the driver is not made feel so uncomfortable with the vibration generated at the normal driving state, while the drive can be made surely recognize the likelihood of collision at the collision-avoidance state.

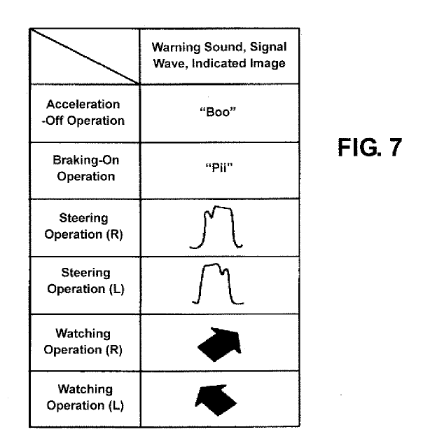

Herein, the warning-sound producer 7, the head-up display output device 8 and the steering-vibration generating actuator 9 may be operated in combination. One example of that is disclosed in FIG. 7.

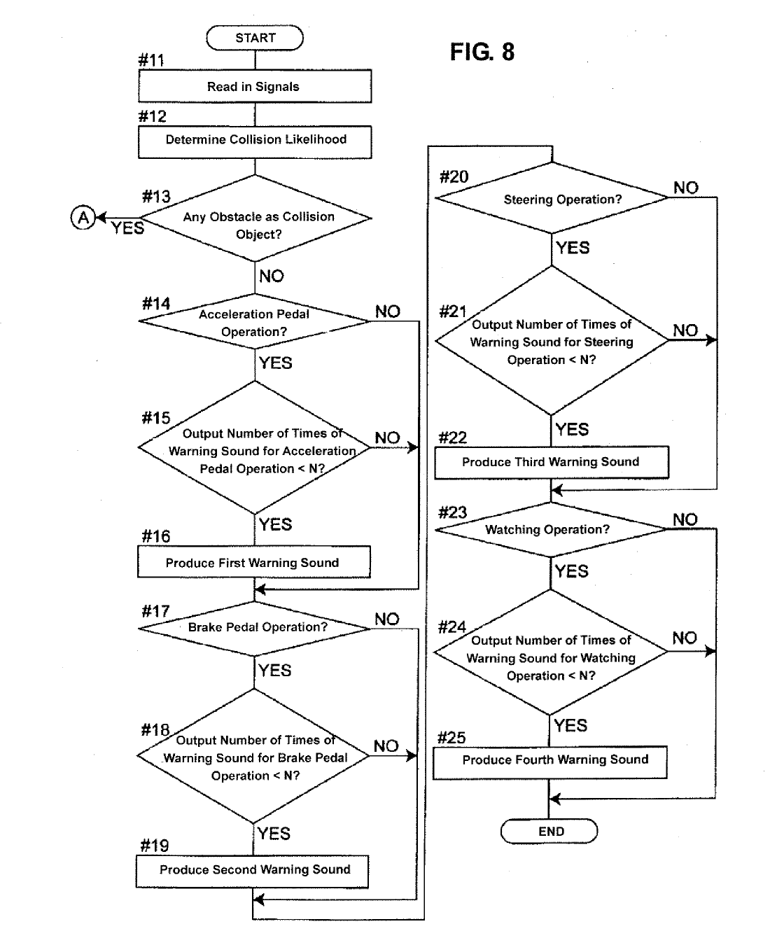

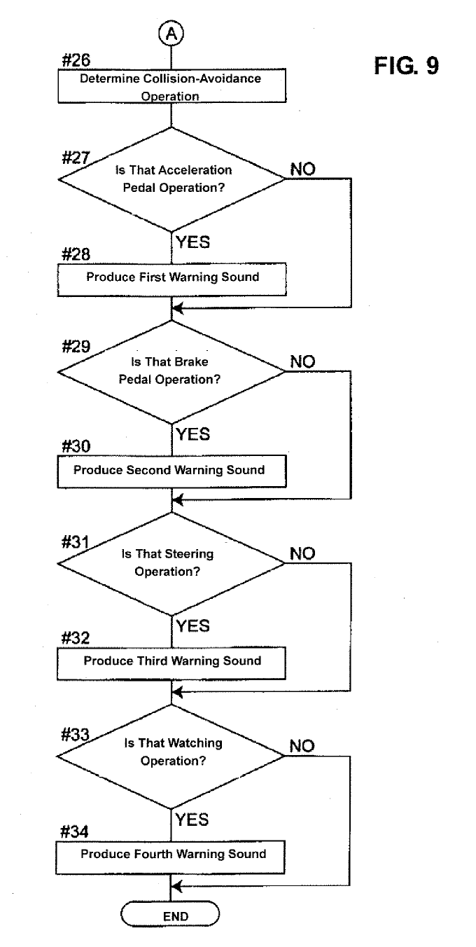

FIGS. 8 and 9 are a first flowchart and a second flowchart of a driving assist processing that is executed by the control unit 10. In these flowcharts, a case in which only the warning-sound producer 7 is used as a device to provide the stimulation is described. Further, although in fact the different stimulations are associated according to the operational directions of the right and the left for the steering operation and the watching operation by the driver, the same processing is described regardless of this difference in these flowcharts for simplification.

First, signals from the various devices and sensors are read in (#11), and then the likelihood of collision is determined based on the signals from any obstacle detecting sensors 2a, 2b and information including a distance between the obstacle and the traveling vehicle 1 and a vehicle's approaching speed (#12). Next, it is determined based on the determination result in a step #12 whether or not there exists any obstacle as an object for collision avoidance (i.e., any obstacle having a high likelihood of collision) (#13). For example, if the time to the collision that may be calculated from the distance between a specified obstacle and the traveling vehicle 1 and the vehicle's approaching speed toward the specified obstacle is shorter than a specified time, it is determined the traveling vehicle 1 may collide against the specified obstacle.

When it is determined that there exists the obstacle as the object for collision avoidance in the step #13, the control sequence proceeds to step #26 in FIG. 9. Meanwhile, when it is determined that there exists no obstacle as the object for collision avoidance, the control sequence proceeds to step #14. In the step #14, it is determined based on the signal from the acceleration pedal sensor 4 whether there is an operation of the acceleration pedal or not (an off-operation of the acceleration pedal in the present embodiment). When it is determined that there is no any acceleration pedal operation, the control sequence proceeds to step #17. Meanwhile, when it is determined that there is the acceleration pedal operation, it is subsequently determined whether or not the output number of times of the warning sound, which corresponds to the number of times of the acceleration pedal operation after the engine start, is less than N (#15).

When it is determined that the output number of times of the warning sound is not less than N in the step #15 (i.e., the output number of times is N or more), the control sequence directly proceeds to the step #17, considering that the acceleration pedal operation and the first warning sound (a “boo” sound in the present embodiment) have been subliminally memorized by the driver in association with each other. When it is determined that the output number of times of the warning sound is still less than N, the control signal is outputted to the warning-sound producer 7 and the first warning sound associated with the acceleration pedal operation is produced (#16), and then the control sequence proceeds to the step #17.

In the step #17, it is determined based on the signal from the brake pedal sensor 5 whether there is an operation of the brake pedal or not (an on-operation of the brake pedal in the present embodiment). When it is determined that there is no any brake pedal operation, the control sequence proceeds to step #20. Meanwhile, when it is determined that there is the brake pedal operation, it is subsequently determined whether or not the output number of times of the warning sound, which corresponds to the number of times of the brake pedal operation after the engine start, is less than N (#18).

When it is determined that the output number of times of the warning sound is not less than N in the step #18 (i.e., the output number of times is N or more), the control sequence directly proceeds to the step #20, considering that the brake pedal operation and the second warning sound (a “pii” sound in the present embodiment) have been subliminally memorized by the driver in association with each other. When it is determined that the output number of times of the warning sound is still less than N, the control signal is outputted to the warning-sound producer 7 and the second warning sound associated with the brake pedal operation is produced (#19), and then the control sequence proceeds to the step #20.

In the step #20, it is determined based on the signal from the steering-angle sensor 3 whether there is an operation of the steering or not. When it is determined that there is no any steering operation, the control sequence proceeds to step #23. Meanwhile, when it is determined that there is the steering operation, it is subsequently determined whether or not the output number of times of the warning sound, which corresponds to the number of times of the steering operation after the engine start, is less than N (#21).

When it is determined that the output number of times of the warning sound is not less than N in the step #21 (i.e., the output number of times is N or more), the control sequence directly proceeds to the step #23, considering that the steering operation and the third warning sound (a “pi” or “pipi” sound in the present embodiment) have been subliminally memorized by the driver in association with each other. When it is determined that the output number of times of the warning sound is still less than N, the control signal is outputted to the warning-sound producer 7 and the third warning sound associated with the steering pedal operation is produced (#22), and then the control sequence proceeds to the step #23.

In the step #23, it is determined based on the signal from the eyes-direction detecting sensor 6 whether there is an operation of watching or not. When it is determined that there is no any watching operation, the control sequence proceeds to the end. Meanwhile, when it is determined that there is the watching operation, it is subsequently determined whether or not the output number of times of the warning sound, which corresponds to the number of times of the watching operation after the engine start, is less than N (#24).

When it is determined that the output number of times of the warning sound is not less than N in the step #24 (i.e., the output number of times is N or more), the control sequence proceeds to the end, considering that the watching operation and the fourth warning sound (a “pu” or “pupu” sound in the present embodiment) have been subliminally memorized by the driver in association with each other. When it is determined that the output number of times of the warning sound is still less than N, the control signal is outputted to the warning-sound producer 7 and the fourth warning sound associated with the watching operation is produced (#25), and then the control sequence proceeds to the end.

The above-described steps #14-#25 are steps for making the driver subliminally memorize the respective driver operations and the different warning sounds in association with each other at the normal driving state. Meanwhile, steps #26-#34 that will be described below are steps for determining the necessary operation to avoid the collision and for outputting (producing) the specified warning sound that is associated with the necessary operation for collision avoidance so as to encourage the driver to conduct the necessary operation for the collision avoidance.

Specifically, a collision-avoidance operation that is necessary to avoid the collision is determined in the step #26. Next, it is determined whether the collision-avoidance operation is the acceleration pedal operation or not (#27). When it is determined that the collision-avoidance operation is not the acceleration pedal operation, the control sequence proceeds to step #29. When it is determined that the collision-avoidance operation is the acceleration pedal operation, the control signal is outputted to the warning-sound producer 7 and the first warning sound associated with the acceleration pedal operation is produced (#28), and then the control sequence proceeds to step #28. Herein, the driver recognizes that the acceleration pedal operation is required now by hearing the first warning sound produced in the step #28. That is, the driver is encouraged to conduct the acceleration pedal operation.

In the step #29, it is determined whether the collision-avoidance operation is the brake pedal operation or not. When it is determined that the collision-avoidance operation is not the brake pedal operation, the control sequence proceeds to step #31. When it is determined that the collision-avoidance operation is the brake pedal operation, the control signal is outputted to the warning-sound producer 7 and the second warning sound associated with the brake pedal operation is produced (#30), and then the control sequence proceeds to step #31. Herein, the driver recognizes that the brake pedal operation is required now by hearing the second warning sound produced in the step #30. That is, the driver is encouraged to conduct the brake pedal operation.

In the step #31, it is determined whether the collision-avoidance operation is the steering operation or not. When it is determined that the collision-avoidance operation is not the steering operation, the control sequence proceeds to step #33. When it is determined that the collision-avoidance operation is the steering operation, the control signal is outputted to the warning-sound producer 7 and the third warning sound associated with the steering pedal operation is produced (#32), and then the control sequence proceeds to step #33. Herein, the driver recognizes that the steering operation is required now by hearing the third warning sound produced in the step #32. That is, the driver is encouraged to conduct the steering operation.

In the step #33, it is determined whether the collision-avoidance operation is the watching operation or not. When it is determined that the collision-avoidance operation is not the watching operation, the control sequence proceeds to the end. When it is determined that the collision-avoidance operation is the watching operation, the control signal is outputted to the warning-sound producer 7 and the fourth warning sound associated with the watching operation is produced (#34), and then the control sequence proceeds to the end. Herein, the driver recognizes that the watching operation is required now by hearing the fourth warning sound produced in the step #34. That is, the driver is encouraged to conduct the watching operation.

As apparent from the above description, according to the present embodiment, the driver is made memorize the stimulation and the specified operation in association with each other, and when there occurs the likelihood of collision of the traveling vehicle against the obstacle, the stimulation associated with the necessary operation to avoid the collision is provided to the driver. Thereby, the driver can be encouraged to reflexively (quickly) conduct the necessary operation to avoid the collision, so that the collision can be avoided surely.

Further, since the subliminal stimulation that is less stimulative than the recognition limit of the driver so as to be memorized by the driver subliminally is provided to the driver at the normal driving state, the driver can be made memorize the stimulation associated with the specified operation subliminally, without letting the driver feel uncomfortable. Also, the recognizable stimulation that is more stimulative than the recognition limit of the driver is provided to the driver at the collision-avoidance state, the driver can be surely encouraged to conduct any necessary operation to avoid the collision.

Also, since providing the driver with the stimulation is cancelled after the specified number of times that is suitable for the driver to subliminally memorize the stimulation and the specified operation in association with each other, processing can be simplified.

The present invention should not be limited to the above-described embodiment, and any other modifications and improvements may be applied in the scope of a sprit of the present invention.

What is claimed is:

1. A driving assist device for a vehicle, comprising:
a specified-operation detecting device operative to detect that a specified operation is conducted by a driver at a normal driving state;
a normal-driving-state stimulation proving device operative to provide the driver with a specified stimulation that is associated with the specified operation when conduction of the specified operation by the driver is detected by said specified-operation detecting device;
a collision-likelihood determining device operative to determine a likelihood of collision of the vehicle against an obstacle;
a collision-avoidance operation determining device operative to determine a necessary operation to be conducted by the driver for avoidance of collision when the likelihood of collision of the vehicle against the obstacle is determined by said collision-likelihood determining device; and
a collision-avoidance-state stimulation proving device operative to provide the driver with a stimulation that is associated with the necessary operation for avoidance of collision so that the driver can be encouraged to conduct the necessary operation for avoidance of collision that is determined by said collision-avoidance operation determining device.

2. The driving assist device for a vehicle of claim 1, wherein said stimulation is configured to be a plurality of recognizable stimulations, which are associated with a specified necessary operation for avoidance of collision, respectively.

3. The driving assist device for a vehicle of claim 1, wherein said necessary operation for avoidance of collision comprises at least one of a steering operation, an acceleration-off operation, a braking-on operation, and a watching operation, and said collision-avoidance operation determining device is configured to determine at least one of the steering operation, acceleration-off operation, braking-on operation, and watching operation as the necessary operation for avoidance of collision to be conducted by the driver.

4. The driving assist device for a vehicle of claim 1, wherein said normal-driving-state stimulation proving device is configured to provide the driver with a subliminal stimulation that is less stimulative than a recognition limit of the driver so as to be memorized by the driver subliminally.

5. The driving assist device for a vehicle of claim 1, wherein said collision-avoidance-state stimulation proving device is configured to provide the driver with a recognizable stimulation that is more stimulative than a recognition limit of the driver.

6. The driving assist device for a vehicle of claim 1, wherein the stimulation provided by said normal-driving-state stimulation proving device is a warning sound.

7. The driving assist device for a vehicle of claim 1, wherein the stimulation provided by said normal-driving-state stimulation proving device is an image indicated on a head-up display.

8. The driving assist device for a vehicle of claim 1, wherein the stimulation provided by said normal-driving-state stimulation proving device is a steering vibration.

9. The driving assist device for a vehicle of claim 1, wherein said normal-driving-state stimulation proving device is configured to provide the driver with the stimulation at specified limited number of times after a vehicle start.
